(19) United States
(12) Patent Application Publication
(10) Pub. No.: US 2002/0164408 A1
(43) Pub. Date: Nov. 7, 2002

(54) Quick-serving pasta

(76) Inventor: Kunihiko Murata, Fukuoka City (JP)

Correspondence Address: Robert H. Johnston III, P.O. Box 121183, Arlington, TX, 76012, US

(21) Appl. No.: 10/121,232

(22) Filed: Apr. 12, 2002

Related U.S. Application Data
(60) Provisional application No. 60/288,866, filed on May 4, 2001.

(51) Int. Cl. A23B 4/00

(52) U.S. Cl. 426/402

(57) ABSTRACT

A method of storing and preparing a quick-serving pasta involves placing a serving of pasta into a sealable package; adding a hydrating and preserving solution into the package in a sufficient quantity to cover the pasta; and vacuum sealing the package. When ready to serve the pasta, the package is opened, and the pasta is placed into boiling water for a sufficient time to heat the pasta and to kill any harmful bacteria.

### RELATED PATENT APPLICATION

This application claims priority of U.S. Provisional Application No. 60/288,866, filed May 4, 2001, entitled, “Quick-serving pasta.”

### TECHNICAL FIELD OF THE INVENTION

The present invention relates to pasta and more particularly to a method for preparing a quick-serving pasta.

### BACKGROUND OF THE INVENTION

Pasta is a favorite food of many around the world. It is made in many ways around the world. In the United States, it is typically made with semolina, which is produced by grinding kernels of durum wheat or other hard wheats. The semolina is mixed with water until it forms a dough. If any other ingredients are being added to the pasta, such as eggs to make egg noodles, or spinach or tomato to make red or green colored pasta, those ingredients are added, and then, the dough is kneaded until it reaches the correct consistency. The dough is then extruded, through a die. The size and shape of the holes in the die determine what the shape of the pasta will be. The pasta make take any of numerous shapes such as rotini, capellini, manicotti, bow ties, ditalini, spaghetti, fettuccine, orzo, vermicelli, penne, zitti, linguine, and rigatoni to name some.

After extrusion, the pasta is then sent through large dryers that circulate hot, moist air to slowly dry the pasta. Because different pasta shapes vary in degrees of thickness, they dry for different lengths of time. Most take 5 or 6 hours to dry. The dried pasta is then packed in bags or boxes. The normal pasta prepared this way usually has a cooking time of about 10 to 12 minutes in boiling water in order to hydrate and gelatinize the starch to provide a cooked product.

While pasta remains popular, there is an increasing demand for pasta that can be quickly cooked. Efforts have been made to provide these pastas. For example, U.S. Pat. No. 6,146,682, entitled, “Wet Toasted Pasta Having Improved Hot Water Pour-Over Rehydration Properties and Method of Manufacture,” presents a pasta that is quick cooking. It is partially pre-cooked and also has internal porous structure to help it cook faster.

In U.S. Pat. No. 4,044,165, wheat semolina, with or without food additives, is mixed with 15 to 20% by weight of cold water on the basis of the weight of the semolina. The dough obtained is cooked during its extrusion under high pressure, at temperatures ranging between 90.degree. C. and 110.degree. C., which causes the gelatinization of the starch. The extrusion-cooked product is then dried down to a moisture level equal to or under 12.5% by weight, and cooled. The end product is rehydrated at the time of consumption by heating in boiling water for less than 5 minutes.

U.S. Pat. No. 4,394,397, presents a process for producing instant-cooking pasta products such as noodles, spaghetti, macaroni and the like having a porous, cellular structure that allegedly enables the products to be rehydrated for consumption within a short period of time while the product continues to exhibit good integrity, firm texture, and desirable flavor upon rehydration.

### SUMMARY OF THE INVENTION

Therefore, a need has arisen for a simple and fast way to package and prepare pasta so that it may be ready for consumption in a minimum amount of time. According to an aspect of the present invention, a method of packaging and preparing a quick-serving pasta involves the steps of placing a serving of pasta into a sealable package; adding a hydrating and preserving solution into the package in a sufficient quantity to cover the pasta; vacuum sealing the package; when ready to serve the pasta, opening the package; and placing the pasta into boiling water for a sufficient time to heat the pasta and to kill any harmful bacteria.

An advantage of the present invention is that good pasta can be prepared in only seconds once water is boiling. Another advantage is that the quick-serving pasta is easily prepared by starting with commercially available pasta.

### BRIEF DESCRIPTION OF THE DRAWINGS

For a more complete understanding of the present invention and advantages thereof, reference is now made to the following description taken in conjunction with the accompanying drawing in which like reference numbers indicate like features, and wherein:

FIG. 1 is a schematic plan view of quick-serving pasta prepared according to the present invention.

### DETAILED DESCRIPTION OF THE INVENTION

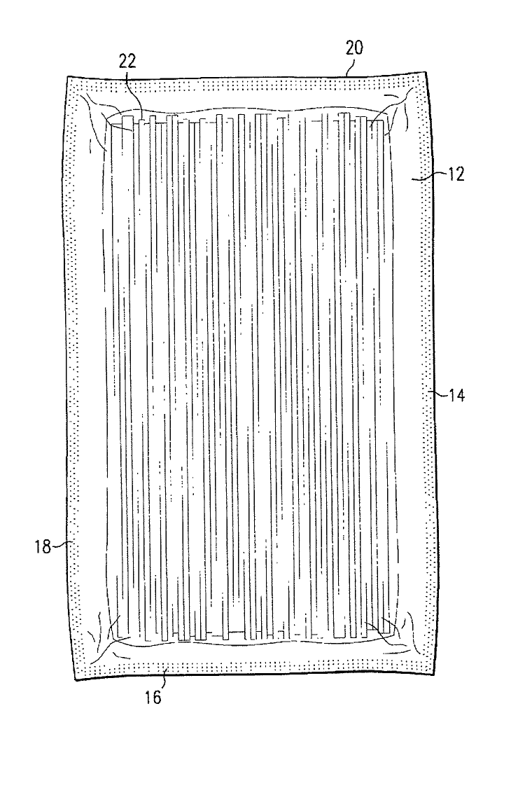

The preferred embodiment of the present invention and its advantages are best understood by referring to FIG. 1. Referring to FIG. 1, a method of packaging a pasta for quick preparation is presented. A sealable package 12 is shown that is preferably a heat sealing plastic package that interfaces with a vacuum heat sealer (not shown) to allow for vacuum sealing of the package 12 at the desired time. Other packages might be used as long as an air-tight seal can be made after any air is substantially removed The package initially has an interior portion formed by three seals 14, 16, and 18 and has an opening on an edge 20. Pasta 22, which is shown as spaghetti (but could be any shape), is placed in the opening of edge 20 to reside in the interior portion of package 12 as shown.

A solution is added that acts to preserve and hydrate the pasta for a storage period. The solution preferably contains water or distilled water and table salt. The concentration is preferably about 50 grams of salt to every three liters of water. Other concentrations may be suitable and other hydrating and preserving solution may be used as well. The solution is added to the interior of package 12 so that the initially hard pasta 22 is sufficiently covered. See example 1 below for a specific illustration with measurements. Once the solution is added, the open edge 20 is heat sealed with a vacuum heat sealer. Once sealed, the quick-serving pasta is complete and need only sit for about 4 to 24 hours before its ready to be used.

When one desires to serve the quick-serving pasta in package 12, the package 12 is opened and the now relatively soft pasta 22 is dropped into boiling water for a sufficient amount of time to heat it and to kill any harmful bacteria. The pasta is then ready to eat. This technique allows the pasta to be stored for two weeks or longer while still allowing it to be served very quickly.

### EXAMPLE 1

A specific example is now given. This example is for illustration purposes and is not intended to limit the invention. One hundred grams of 100% durum semolina spaghetti was placed in a sealable, water-tight package. The package was about a 3.5 inch by 13.75 inch sleeve of the type shown in FIG. 1. Then about four ounces of a salt-water solution was added to the package. The salt water solution was prepared by mixing 3 liters of water with 50 grams of table salt. The sealable bag was then vacuum sealed. Within a about six hours, the pasta changed color slightly and absorbed some of the salt-water. The pasta was then ready for use when desired. When it was time to serve the pasta, the sealable package was opened, and the pasta was removed and placed in boiling water for about 15 seconds. The pasta was hot and ready to eat “al dente.”

Although the present invention and its advantages have been described in detail, it should be understood that various changes, substitutions and alterations can be made therein without departing from the spirit and scope of invention as defined by the appended claims.

What is claimed is:

1. A method for preparing a quick-serving pasta, the method comprising the steps of:
placing a serving of pasta in a sealable package;
adding a hydrating and preserving solution in a sufficient quantity to cover the pasta; and
vacuum sealing the package.

2. The method of claim 1 wherein the step of adding a hydrating and preserving solution comprises the step of adding a salt water solution, which has a concentration given when 3 liters of water is mixed with about 50 grams of table salt, into the package in a sufficient quantity to cover the pasta.
The method of claim 1 wherein step of placing a serving of pasta in a sealable package comprises the step of placing spaghetti pasta in a plastic sleeve having dimensions of about 3.5 inches by 13.8 inches and sealed along three edges;
wherein the step of adding a hydrating and preserving solution comprises the step of adding a salt water solution, which has a concentration given when 3 liters of water is mixed with about 50 grams of table salt, into the package in a sufficient quantity to cover the pasta.; and
wherein the step of vacuum sealing the package comprises the step of vacuum sealing the final edge to form a sealed package containing spaghetti past covered with the hdyrating and preserving solution.

3. A method for preparing a quick-serving pasta, the method comprising the steps of:
placing a serving of pasta into a heat sealable package;
adding a salt water solution, which is made with the concentrations given when 3 liters of water is mixed with about 50 grams of table salt, into the package in a sufficient quantity to cover the pasta; and
vacuum sealing the package.

4. A method of storing and preparing a quick-serving pasta, the steps comprising:
placing a serving of pasta into a sealable package;
adding a salt water solution, which is made with the concentrations given when 3 liters of water is mixed with about 50 grams of table salt, into the package in a sufficient quantity to cover the pasta;
vacuum sealing the package;
when ready to serve the pasta, opening the package; and
placing the pasta into boiling water for a sufficient time to heat the pasta and to kill any harmful bacteria.

5. The method of claim 4, wherein the time to heat the pasta and kill any harmful bacteria is less than 30 seconds.
